(19) United States
(12) Patent Application Publication
(10) Pub. No.: US 2012/0245254 A1
(43) Pub. Date: Sep. 27, 2012

(54) INORGANIC BOARD AND INORGANIC BOARD PRODUCTION METHOD

(76) Inventor: Susumu SHIMANO, Handa-shi (JP)

(21) Appl. No.: 13/071,833

(22) Filed: Mar. 25, 2011

(51) Int. Cl. C04B 16/06; B29C 70/34

(52) U.S. Cl. 524/8; 264/241

(57) ABSTRACT

An inorganic board is obtained by extrusion molding of raw material composition, contains cement and silica-containing material in weight ratio ranging from 45:55 to 55:45, contains 3 to 8 wt %, with respect to total solids, of organic fibers. In the inorganic board, specific gravity ranges from 1.4 to 2.0, flexural strength is not lower than 20 N/mm², dimensional change rate upon ten-day moisture release at 80° C. is not greater than 0.1%, dimensional change rate upon seven-day moisture absorption is not greater than 0.1%, seven-day dimensional change rate in an environment having carbon dioxide concentration of 5% is not greater than 0.1%. A method for producing the inorganic board comprises the steps of producing raw material composition that comprises cement, silica-containing material and organic fibers; producing mat by extrusion molding of the raw material composition; and subjecting the mat to autoclave curing at 140 to 200° C.

### BACKGROUND OF THE INVENTION

1. Field of the Invention

The present invention relates to an inorganic board suitable for building boards, and to a method for producing such an inorganic board.

2. Description of the Related Art

Conventional inorganic boards have, as main components, a hydraulic inorganic powder such as a cement or the like, and a woody reinforcement such as wood pulp fibers. For instance, Japanese Patent Application Publication No. 2008-162833 discloses a method for producing an inorganic board that comprises the steps of kneading a cement-based material, a fine powdery silica-containing material, a coarse powdery silica-containing material, wood flour and pulp, with an adequate quantity of water, to prepare a raw material composition; extrusion-molding the raw material composition; and hardening and curing an extruded molding intermediate body in the extrusion molding step. Such an inorganic board has excellent characteristics in terms of, for instance, flexural strength. Therefore, the inorganic board is used as a building board in, for instance, inner wall materials and outer siding materials in houses.

In recent years, the use of inorganic boards has expanded, and studies have been conducted on the use of such inorganic boards in the construction of, for instance, middle-rise buildings. However, middle-rise buildings reach heights of 36 m, where wind pressure is high. The wind pressure resistance of inorganic boards used in the construction of the building must be enhanced accordingly. In recent years, moreover, long-term durability requirements in houses have become more demanding, and hence the inorganic boards must exhibit yet better long-term durability. Herein, long-term durability denotes little dimensional changes and little loss of properties over periods of time of 10 years or longer.

### SUMMARY OF THE INVENTION

Therefore, it is an object of the present invention to provide an inorganic board having excellent wind pressure resistance and long-term durability, and to provide a method for producing the inorganic board.

The inorganic board of the present invention is obtained by extrusion molding of a raw material composition that comprises a cement, a silica-containing material and organic fibers. In the inorganic board, the weight ratio of the content of the cement and the silica-containing material ranges from 45:55 to 55:45, and the content of organic fibers ranges from 3 to 8 wt % with respect to total solids. The inorganic board has a specific gravity ranging from 1.4 to 2.0, a dimensional change rate upon ten-day moisture release at 80° C. not greater than 0.1%, a dimensional change rate upon seven-day moisture absorption no greater than 0.1%, a seven-day dimensional change rate in an environment having a carbon dioxide concentration of 5% no greater than 0.1%, and a flexural strength not lower than 20 N/mm². Herein, flexural strength is a value measured in accordance with JIS A 1408. A flexural strength of 20 N/mm² or greater makes for excellent wind pressure resistance, enough for passing a wind pressure resistance test under harsh conditions, namely a height of 36 m and a wind pressure of 46 m/minute The moisture release dimensional change rate is a value arrived at by bringing a specimen to an equilibrium state in a constant-temperature constant-humidity chamber at 20° C. and 60% humidity, measuring then the length (l₁) of the specimen, placing the specimen in a dryer at 80° C., and after 10 days, removing the specimen from the dryer, measuring again the length (l₂) of the specimen, and dividing (l₁-l₂) by l₂ and multiplying by 100. The moisture absorption dimensional change rate is a value obtained by bringing a specimen to an equilibrium state in a constant-temperature constant-humidity chamber at 20° C. and 60% humidity, measuring then the length (l₃) of the specimen, immersing the specimen in water, and after seven days, removing the specimen from the water, wiping off the water adhered to the surface using a cloth, measuring again the length (l₄) of the specimen, and dividing (l₄-l₃) by l₃ and multiplying by 100. The seven-day dimensional change rate in an environment having a carbon dioxide concentration of 5% is a value arrived at by bringing a specimen to an equilibrium state in a constant-temperature constant-humidity chamber at 20° C. and 60% humidity, measuring then the length (l₅) of the specimen, exposing thereafter the specimen to an environment having a carbon dioxide concentration of 5%, for 7 days, measuring then again the length (l₆) of the specimen, and dividing (l₅-l₆) by l₅ and multiplying by 100. The dimensional change rate upon ten-day moisture release at 80° C. denotes the degree of dimensional change derived from moisture release. The dimensional change rate upon seven-day moisture absorption denotes the degree of dimensional change due to moisture absorption. The seven-day dimensional change rate in an environment having a carbon dioxide concentration of 5% denotes the degree of dimensional change due to carbonation. Inorganic boards having values no greater than 0.1% for the foregoing change rates exhibit little deterioration over the years, and boast excellent dimensional stability. As a result, the properties of the boards are little impaired even over long periods of time after construction. Such boards are thus useful as building boards having long-term durability. Preferably, the inorganic board of the present invention comprises 3 to 15 wt % of silica fume, with respect to total solids, as the silica-containing material, since flexural strength is excellent in that case. The silica-containing material may be silica fume and silica sand. Preferably, the organic fibers are a pulp and polypropylene fibers, since in that case appropriate deflection is achieved, and workability is excellent. Preferably, the inorganic board comprises 3 to 5 wt % of mica with respect to total solids, and 0.5 to 1.5 wt %, with respect to total solids, of montmorillonite coated with fatty acid calcium, since dimensional stability is excellent in that case. Preferably, the thickness of the board ranges from 6 to 25 mm, since such a thickness makes for easier transport and construction.

The present invention provides also a method for producing an inorganic board. The method for producing an inorganic board of the present invention comprises the steps of producing a raw material composition that comprises a cement, a silica-containing material and organic fibers; producing a mat by extrusion molding of the obtained raw material composition; and curing the mat. In the step of producing a raw material composition, the weight ratio of the cement and the silica-containing material in the raw material composition is set to range from 45:55 to 55:45, and the content of organic fibers with respect to total solids is set to range from 3 to 8 wt %. The curing step is carried out by autoclave curing at 140 to 200° C. As a result there can be produced an inorganic board having excellent wind pressure resistance and long-term durability. In the step of producing a raw material composition, preferably, the content of silica fume as the silica-containing material ranges from 3 to 15 wt % with respect to total solids in the raw material composition, since in that case the obtained inorganic board exhibits excellent flexural strength. Silica fume and silica sand may be used as the silica-containing material in the raw material composition. In the step of producing a raw material composition, preferably, a pulp and polypropylene fibers are used as the organic fibers, since in that case the obtained inorganic board has appropriate deflection and excellent workability. In the step of producing a raw material composition, preferably, the content of mica ranges from 3 to 5 wt % with respect to total solids, and the content of montmorillonite coated with fatty acid calcium ranges from 0.5 to 1.5 wt % with respect to total solids, since in that case the obtained inorganic board exhibits excellent dimensional stability. Preferably, the board thickness ranges from 6 to 25 mm, since in that case production costs are lower and productivity excellent.

The present invention succeeds in providing an inorganic board having excellent wind pressure resistance and long-term durability, and in providing a method for producing the inorganic board.

### DESCRIPTION OF THE PREFERRED EMBODIMENTS

Embodiments of the present invention are explained in detail below.

The inorganic board of the present invention is obtained through extrusion molding of a raw material composition that comprises a cement, a silica-containing material and organic fibers.

Examples of the cement include, for instance, Portland cement, high early-strength cement, alumina cement, fly ash cement, blast-furnace slag cement, silica cement, white cement or the like. In the present invention there maybe incorporated one type alone, or two or more types, of any of the foregoing materials.

Examples of the silica-containing material include, for instance, silica sand, silica powder, silica flour, silica fume, fly ash, blast furnace slag, Shirasu balloons, perlite, diatomaceous earth and the like. In the present invention there may be incorporated one type alone, or two or more types, of any of the foregoing materials.

Examples of organic fibers include, for instance, natural fibers and synthetic fibers. Natural fibers include animal fibers such as silk, wool, animal hair or the like, or plant fibers such as wood flour, wood chips, wood wool, wood fibers or the like. Herein, however, there are preferably used are wood fibers such as used paper, needle-leaves-tree unbleached kraft pulp (NUKP), needle-leaves-tree bleached kraft pulp (NBKP), laubholz unbleached kraft pulp (LUKP), laubholz bleached kraft pulp (LBKP) and the like, more preferably, wood fibers having an average fiber length ranging from 0.3 to 1.5 mm, since excellent properties, such as strength, can be obtained in that case. Examples of synthetic fibers include, for instance, polyamide fibers, polyvinyl alcohol fibers, polyester fibers, polypropylene fibers, acrylic fibers, polyurethane fibers, polyolefin fibers, glass fibers, ceramic fibers and the like. In the present invention there may be incorporated one type alone, or two or more types, of any of the above organic fibers. Preferably, wood fibers and synthetic fibers are concomitantly used, since excellent properties, in terms of strength, deflection and so forth, are achieved in that case.

Mica can also be used as a raw material besides the above-described ones. Preferably, the mica is flake-like mica having an average particle size ranging from 200 to 700 μm and an aspect ratio ranging from 60 to 100. Mica is preferred since it ordinarily has a lamellar structure, is not hygroscopic, and is a stiff, highly elastic material. This allows enhancing the dimensional stability of the inorganic board.

Montmorillonite covered with fatty acid calcium can also be used. Using montmorillonite covered with fatty acid calcium is preferred, since doing so allows reducing water absorption by the inorganic board, and allows enhancing flexural strength and dimensional stability.

A cement composition may also be used. As the cement composition there can be used, for instance, defective inorganic boards before hardening or defective inorganic boards after hardening, produced in a production process, as well as scraps, waste and the like of inorganic boards gathered at a construction site. All such materials are used after pulverization, in an impact mill and/or abrasion mill, to an average particle size of 50 to 150 μm. Using the above cement composition allows reducing manufacturing costs while reducing industrial waste.

In order to lower the extrusion pressure and to improve formability, there may be used an extrusion aid in the form of a cellulose derivative such as methyl cellulose, ethyl cellulose, carboxymethyl cellulose or hydroxymethyl cellulose; or polyvinyl alcohol , a water-soluble polymer, a water-absorbing polymer or the like.

There may also be used water-reducing agents of carboxylic acid type, sulfonic acid type, or polyethylene glycol type; weight-reducing materials such as plastic foam or crushed plastic foam ; hardening accelerators such as calcium chloride, magnesium chloride, potassium sulfate, calcium sulfate, magnesium sulfate, aluminum sulfate, sodium aluminate, potassium aluminate, calcium formate, calcium acetate, calcium acrylate, water glass or the like; mineral powders such as bentonite, vermiculite or the like; water-repelling agents and/or waterproofing agents such as natural and synthetic waxes, paraffin, silicone, succinic acid or metal salts of higher fatty acids; aqueous pastes such as carboxymethyl cellulose; or a reinforcing agent of a styrene-butadiene latex or a synthetic resin emulsion such as an acrylic resin emulsion or the like.

The inorganic board of the present invention is obtained by extrusion molding of a raw material composition that comprises a cement, a silica-containing material and organic fibers, such that the weight ratio of the content of the cement and the silica-containing material ranges from 45:55 to 55:45, and the content of organic fibers ranges from 3 to 8 wt % with respect to total solids. Also, specific gravity ranges from 1.4 to 2.0, the dimensional change rate upon ten-day moisture release at 80° C. is no greater than 0.1%, the dimensional change rate upon seven-day moisture absorption is no greater than 0.1%, the seven-day dimensional change rate in an environment having a carbon dioxide concentration of 5% is no greater than 0.1%, and the flexural strength is not lower than 20 N/mm². By virtue of the above characteristics, the inorganic board, a production method whereof is described below, yields a building board having excellent wind pressure resistance and long-term durability, and which can be used as a building board in outer sidings and inner walls. The thickness of the board is not particularly limited, but ranges preferably from 6 to 25 mm, since such a thickness makes for lower production costs, excellent productivity, easier transport and easier construction.

When the weight ratio of the content of cement and silica-containing material ranges from 45:55 to 55:45, hydrothermal reactions during autoclave curing proceed smoothly, the amount of tobermorite produced is large, and the matrix becomes finer, whereby the obtained inorganic board can exhibit sufficient strength and small dimensional change rate. The rationale for a content of organic fibers of 3 to 8 wt % with respect to total solids is that a content in excess of 8 wt % may hinder cement hardening, and may cause the obtained inorganic board to have lower strength, while a content smaller than 3 wt % may prevent the inorganic board from exhibiting sufficient deflection. Preferably, the mica is incorporated in an amount ranging from 3 to 5 wt % with respect to total solids, and montmorillonite coated with fatty acid calcium is incorporated in an amount ranging from 0.5 to 1.5 wt % with respect to total solids, since dimensional stability is yet better in that case.

The inorganic board of the present invention can be produced by extrusion molding of a raw material composition.

The production method of the present invention comprises the steps of producing a raw material composition that comprises a cement, a silica-containing material and organic fibers; producing a mat by extrusion molding of the obtained raw material composition; and curing the mat.

The step of producing a raw material composition involves mixing a cement, a silica-containing material and organic fibers with an appropriate amount of water, with kneading. Kneading is carried out preferably using a kneader-ruder or the like . The raw material composition is adjusted to a solids concentration ranging from 67 to 83 wt %. The rationale for setting the solids concentration of the raw material composition to be not higher than 83 wt % is that a solids concentration in excess of 83 wt % makes extrusion molding difficult and productivity is poor. The rationale for setting the solids concentration to be not lower than 67 wt % is that a solids concentration lower than 67 wt % causes the mat obtained by extrusion molding to have a low specific gravity. Also, the dewatering involved takes time, which detracts from productivity.

The step of producing a mat through extrusion molding the obtained raw material composition involves charging the raw material composition, with the solids concentration thereof adjusted as described above, in an extruder, and extruding the mixture out of a die of the extruder, to produce a plate-like mat. The extrusion pressure ranges ordinarily from 0.5 to 3 MPa. A textured pattern can be formed on the obtained mat by pressing a formboard against the surface of the mat.

The step of curing the mat is accomplished by autoclave curing at 140 to 200° C. Autoclave curing is carried out at a pressure of 0.5 MPa or higher for 7 to 15 hours . Such autoclave curing allows hydrothermal reactions to proceed smoothly, and allows increasing the amount of tobermorite, so that the matrix becomes finer, as a result of which the obtained inorganic board can exhibit sufficient strength and a small dimensional change rate. Preferably, autoclave curing is carried out after steam curing at a temperature not higher than 100° C., since in that case productivity is excellent, and the properties of the obtained inorganic board are likewise excellent.

Examples of the present invention are explained next.

Portland cement, silica sand, pulp and so forth were mixed with water and were kneaded to yield raw material compositions. Each raw material composition was extruded through the die of an extruder, to prepare a plate-like mat that was then subjected to autoclave curing, to produce inorganic boards of Examples 1 to 7 and Comparative examples 1 to 4. Table 1 gives the proportion of each raw material composition with respect to total solids in the raw material composition, as well as the solids concentration and the autoclave curing temperature.

The obtained inorganic boards of Examples 1 to 7 and Comparative examples 1 to 4 were subjected to measurements of specific gravity, thickness, flexural strength, dimensional change rate upon ten-day moisture release at 80° C., dimensional change rate upon seven-day moisture absorption, and seven-day dimensional change rate in an environment having a carbon dioxide concentration of 5%. The results are given in Table 1.

TABLE 1

| | | | Ex. 1 | Ex. 2 | Ex. 3 | Ex. 4 | Ex. 5 | Ex. 6 |
|---|---|---|---|---|---|---|---|---|
| Solids | Portland cement | wt % | 44.5% | 40.6% | 40.6% | 40.6% | 41.8% | 44.3% |
| composition | Silica sand | wt % | 29.7% | 36.0% | 41.0% | 43.0% | 47.3% | 37.3% |
| of raw | Silica fume | wt % | 15.0% | 10.0% | 5.0% | 3.0% | 0.0% | 10.0% |
| material | Pulp | wt % | 5.0% | 5.0% | 5.0% | 5.0% | 5.0% | 5.0% |
| composition | Polypropylene | wt % | 0.8% | 1.2% | 1.2% | 1.2% | 1.2% | 1.2% |
| | fibers | | | | | | | |
| | Mica | wt % | 3.0% | 5.0% | 5.0% | 5.0% | 5.0% | 0.0% |
| | Montmorillonite | wt % | 1.0% | 1.0% | 1.0% | 1.0% | 0.5% | 1.0% |
| | coated with fatty | | | | | | | |
| | acid calcium | | | | | | | |
| | Methyl cellulose | wt % | 1.0% | 1.2% | 1.2% | 1.2% | 1.2% | 1.2% |
| | Sub total | wt % | 100.0% | 100.0% | 100.0% | 100.0% | 102.0% | 100.0% |
| Production | Solids | wt % | 77% | 77% | 77% | 77% | 77% | 77% |
| conditions | concentration in | | | | | | | |
| | raw material | | | | | | | |
| | composition | | | | | | | |
| | Autoclave curing | ° C. | 170 | 170 | 170 | 170 | 170 | 170 |
| | temperature | | | | | | | |
| Properties | Specific gravity | — | 1.63 | 1.50 | 1.49 | 1.46 | 1.53 | 1.53 |
| | Thickness | mm | 13.3 | 14.0 | 13.9 | 14.2 | 14.3 | 14.2 |
| | Flexural strength | N/mm² | 29.3 | 25.8 | 23.2 | 22.4 | 21.1 | 26.3 |
| | Dimensional change | % | 0.08 | 0.07 | 0.08 | 0.07 | 0.08 | 0.07 |
| | rate upon 10-day | | | | | | | |
| | moisture release at | | | | | | | |
| | 80° C. | | | | | | | |
| | Dimensional change | % | 0.08 | 0.06 | 0.07 | 0.07 | 0.05 | 0.06 |
| | rate upon 7-day | | | | | | | |
| | moisture | | | | | | | |
| | absorption | | | | | | | |
| | 7-day dimensional | % | 0.00 | 0.01 | 0.01 | 0.01 | 0.01 | 0.01 |
| | change rate in an | | | | | | | |
| | environment having | | | | | | | |
| | a carbon dioxide | | | | | | | |
| | concentration of 5% | | | | | | | |

| | | | | Comp. | Comp. | Comp. | Comp. |
|---|---|---|---|---|---|---|---|
| | | | Ex. 7 | ex. 1 | ex. 2 | ex. 3 | ex. 4 |
| Solids | Portland cement | wt % | 40.8% | 62.4% | 42.4% | 44.5% | 44.5% |
| composition | Silica sand | wt % | 36.2% | 26.8% | 27.6% | 29.7% | 29.7% |
| of raw | Silica fume | wt % | 10.0% | 0.0% | 15.0% | 15.0% | 15.0% |
| material | Pulp | wt % | 5.0% | 5.0% | 8.0% | 5.0% | 5.0% |
| composition | Polypropylene | wt % | 0.8% | 0.8% | 2.0% | 0.8% | 0.8% |
| | fibers | | | | | | |
| | Mica | wt % | 5.0% | 3.0% | 3.0% | 3.0% | 3.0% |
| | Montmorillonite | wt % | 1.0% | 1.0% | 1.0% | 1.0% | 1.0% |
| | coated with fatty | | | | | | |
| | acid calcium | | | | | | |
| | Methyl cellulose | wt % | 1.2% | 1.0% | 1.0% | 1.0% | 1.0% |
| | Sub total | wt % | 100.0% | 100.0% | 100.0% | 100.0% | 100.0% |
| Production | Solids | wt % | 77% | 77% | 77% | 77% | 65% |
| conditions | concentration in | | | | | | |
| | raw material | | | | | | |
| | composition | | | | | | |
| | Autoclave curing | ° C. | 170 | 170 | 170 | 120 | 170 |
| | temperature | | | | | | |
| Properties | Specific gravity | — | 1.47 | 1.49 | 1.21 | 1.45 | 1.12 |
| | Thickness | mm | 13.9 | 14.0 | 13.8 | 14.2 | 13.9 |
| | Flexural strength | N/mm² | 25.3 | 21.3 | 18.0 | 18.2 | 15.1 |
| | Dimensional change | % | 0.08 | 0.09 | 0.11 | 0.10 | 0.10 |
| | rate upon 10-day | | | | | | |
| | moisture release at | | | | | | |
| | 80° C. | | | | | | |
| | Dimensional change | % | 0.07 | 0.08 | 0.11 | 0.12 | 0.10 |
| | rate upon 7-day | | | | | | |
| | moisture | | | | | | |
| | absorption | | | | | | |
| | 7-day dimensional | % | 0.01 | 0.15 | 0.19 | 0.25 | 0.28 |
| | change rate in an | | | | | | |
| | environment having | | | | | | |
| | a carbon dioxide | | | | | | |
| | concentration of 5% | | | | | | |

The inorganic boards of Examples 1 to 7 had a specific gravity ranging from 1.4 to 1.6, and excellent flexural strength, greater than 20 N/mm². All the boards of Examples 1 to 7 exhibited also excellent dimensional change rate upon ten-day moisture release at 80° C., dimensional change rate upon seven-day moisture absorption, and seven-day dimensional change rate in an environment having a carbon dioxide concentration of 5%, with values smaller than 0.1% for all the foregoing.

By contrast, the inorganic board of Comparative example 1, in which the weight ratio of the content of cement and silica-containing material was 70:30, exhibited poor dimensional stability, with a seven-day dimensional change rate in an environment having a carbon dioxide concentration of 5% that was greater than 0.15%.

The inorganic board of Comparative example 2, which contained a total 10 wt % of pulp and polypropylene fibers, had a low specific gravity, of 1.21, and flexural strength lower than 20 N/mm². The board exhibited poor dimensional stability, in that the dimensional change rate upon ten-day moisture release at 80° C., dimensional change rate upon seven-day moisture absorption, and seven-day dimensional change rate in an environment having a carbon dioxide concentration of 5% were all greater than 0.10.

The inorganic board of Comparative example 3, produced at an autoclave curing temperature of 120° C., exhibited a flexural strength lower than 20 N/mm². The board exhibited poor dimensional stability, in that the dimensional change rate upon seven-day moisture absorption and the seven-day dimensional change rate in an environment having a carbon dioxide concentration of 5% were both greater than 0.1%.

The inorganic board of Comparative example 4, manufactured at a solids concentration of 65 wt % of the raw material composition, had a low specific gravity, of 1.12, a flexural strength lower than 20 N/mm², and seven-day dimensional change rate in an environment having a carbon dioxide concentration of 5% that was greater than 0.1%.

An embodiment of the present invention has been explained above, but the present invention is not limited thereto, and may accommodate all manner of variations within the scope of the invention as set forth in the appended claims.

As explained above, the present invention succeeds in providing an inorganic board having excellent wind pressure resistance and long-term durability, and in providing a method for producing the inorganic board.

What is claimed is:

1. An inorganic board obtained by extrusion molding of a raw material composition that comprises a cement, a silica-containing material and organic fibers, wherein
the inorganic board contains the cement and the silica-containing material in a weight ratio ranging from 45:55 to 55:45; and
contains 3 to 8 wt o, with respect to total solids, of the organic fibers,
specific gravity ranges from 1.4 to 2.0,
a dimensional change rate upon ten-day moisture release at 80° C. is not greater than 0.1%,
a dimensional change rate upon seven-day moisture absorption is not greater than 0.1%,
a seven-day dimensional change rate in an environment having a carbon dioxide concentration of 5% is not greater than 0.1%, and
flexural strength is not lower than 20 N/mm².

2. The inorganic board according to claim 1, containing silica fume as the silica-containing material, in an amount ranging from 3 to 15 wt % with respect to total solids.

3. The inorganic board according to claim 2, wherein the silica-containing material is silica fume and silica sand.

4. The inorganic board according to claim 1, wherein the organic fibers are a pulp and polypropylene fibers.

5. The inorganic board according to claim 1, containing 3 to 5 wt % of mica with respect to total solids, and comprising 0.5 to 1.5 wt %, with respect to total solids, of montmorillonite coated with fatty acid calcium.

6. A method for producing an inorganic board, comprising the steps of:
producing a raw material composition that comprises a cement, a silica-containing material and organic fibers;
producing a mat by extrusion molding of the obtained raw material composition; and
curing the mat, wherein
in the step of producing a raw material composition, the weight ratio of the cement and the silica-containing material in the raw material composition is set to range from 45:55 to 55:45, and the content of organic fibers with respect to total solids is set to range from 3 to 8 wt %, and
the step of curing is carried out by autoclave curing at 140 to 200° C.

7. The method for producing an inorganic board according to claim 6, wherein in the step of producing a raw material composition, the content of silica fume as the silica-containing material ranges from 3 to 15 wt % with respect to total solids in the raw material composition.

8. The method for producing an inorganic board according to claim 7, wherein in the step of producing a raw material composition, silica fume and silica sand are used as the silica-containing material in the raw material composition.

9. The method for producing an inorganic board according to claim 6, wherein in the step of producing a raw material composition, a pulp and polypropylene fibers are used as the organic fibers.

10. The method for producing an inorganic board according to claim 6, wherein in the step of producing a raw material composition, the content of mica ranges from 3 to 5 wt % with respect to total solids, and the content of montmorillonite coated with fatty acid calcium ranges from 0.5 to 1.5 wt % with respect to total solids.
